(19) United States
(12) Patent Application Publication
(10) Pub. No.: US 2013/0073504 A1
(43) Pub. Date: Mar. 21, 2013

(54) SYSTEM AND METHOD FOR DECISION SUPPORT SERVICES BASED ON KNOWLEDGE REPRESENTATION AS QUERIES

(71) Applicants: Ajay Mohindra, Hawthorne, NY (US); Anca Sailer, Hawthorne, NY (US); Daniel M. Dias, Hawthorne, NY (US); David J. Lillethun, Dunwoody, GA (US)

(72) Inventors: Ajay Mohindra, Hawthorne, NY (US); Anca Sailer, Hawthorne, NY (US); Daniel M. Dias, Hawthorne, NY (US); David J. Lillethun, Dunwoody, GA (US)

(73) Assignee: International Business Machines Corporation, Armonk, NY (US)

(21) Appl. No.: 13/236,096

(22) Filed: Sep. 19, 2011

(51) Int. Cl. G06N 5/02

(52) U.S. Cl. 706/46

(57) ABSTRACT

In a method for decision support, a request for information that is part of a context is received, data is generated in response the request, a knowledge model associated with the context is populated with the data, the knowledge model is populated with real-time data associated with the request, the knowledge model is executed, and a result of the executed knowledge model is output.

### BACKGROUND

1. Technical Field

The present invention relates to decision support systems.

2. Discussion of the Related Art

Business or organizational decisions can involve a high volume of labor intensive and time-consuming activities, including repetitive costs in contexts and issues that have been addressed on previous occasions with similar resolutions. For example, all of a company's current information assets including legacy and relational data sources, cubes, data warehouses, and data marts may need to be accessed to make a decision.

To support such business or organizational decision-making activities, decision support systems (DSSs) have been developed. In general, a DSS is an interactive software-based system intended to help decision makers compile useful information from a combination of raw data, documents, personal knowledge, or business models to identify and solve problems and make decisions.

For example, a national on-line book seller wants to begin selling its products internationally but first needs to determine if that will be a wise business decision. The vendor can use a DSS to gather information from its own resources (using a tool such as online analytical processing (OLAP)) to determine if the company has the ability or potential ability to expand its business and also from external resources, such as industry data, to determine if there is indeed a demand to meet. The DSS will collect and analyze the data and then present it in a way that can be interpreted by humans.

As can be seen, the context and decision data is available in many cases; however, it may be buried in formats and systems not easy to leverage. For example, the context and decision data may be located in business charts, medical records, consulting tapes, unfederated databases, etc., thus making the contexts matching and the capturing of the human decisions challenging undertakings.

### BRIEF SUMMARY

The present invention discloses a methodology to provide decision-making support as a service-based inference of contexts and decision models from any available source of data in a given environment.

Exemplary embodiments of the present invention provide a method, system and computer program product for decision support. In the method, a request for information that is part of a context is received, data is generated in response the request, a knowledge model associated with the context is populated with the data, the knowledge model is populated with real-time data associated with the request, the knowledge model is executed, and a result of the executed knowledge model is output.

### BRIEF DESCRIPTION OF THE SEVERAL VIEWS OF THE DRAWINGS

FIG. 1 is a diagram illustrating decision service components according to an exemplary embodiment of the present invention;

FIG. 2 is a flowchart illustrating a decision service methodology according to an exemplary embodiment of the present invention; and

FIG. 3 illustrates an apparatus for implementing exemplary embodiments of the present invention.

### DETAILED DESCRIPTION

An exemplary embodiment of the present invention discloses a methodology to provide decision-making support as a service-based inference of contexts and decision models from any available source of data in a given environment. By leveraging the contexts and decision models any source of data in a given environment, the methodology may be considered a multi-domain joint decision service.

A context may be specified via a computer application that asks for user input for a task-at-hand. For example, in the case of “I want to travel from home to work. What route do I take?” the computing application may ask for “Starting location,” “Ending location,” and “Mode of transport.” This is the context. Context in the case of a medical application would be different. For example, in the case of “I have a patient who requires blood thinning medication. What dosage do I prescribe?” the computing application may ask for “Gender,” “Height,” “Weight,” “Current medications,” and “Medication history.” This is the context.

Exemplary decision models leveraged by exemplary embodiments of this invention may include those employed by any number of decision support systems (DSSs) including, but not limited to, a communication-driven DSS that supports more than one person working on a shared task; examples include Microsoft's NetMeeting or Groove. A data-driven DSS or data-oriented DSS, which emphasizes access to and manipulation of a time series of internal company data and, sometimes, external data. A document-driven DSS that manages, retrieves, and manipulates unstructured information in a variety of electronic formats. A knowledge-driven DSS that provides specialized problem-solving expertise stored as facts, rules, procedures, or in similar structures. A model-driven DSS that emphasizes access to a manipulation of a statistical, financial, optimization, or simulation model. Model-driven DSSs may use data and parameters provided by users to assist decision makers in analyzing a situation. Dicodess is an example of an open source model-driven DSS generator.

Imagine, for example, that a high school football coach poses the question—“Should we have the team's football practice this afternoon?” The context may take into account the following set of input data: 1) the team's vital history from their medical records—susceptibility to heat, allergies, etc.; 2) predicted weather conditions—temperature, humidity, ozone alerts, heat advisory, etc.; and 3) predicted allergy indicators. Based on the sophistication of the models employed by a system operating the methodology according to an exemplary embodiment of the present invention, the system would provide guidance to the coach regarding whether or not to conduct practice. Details regarding how the system answers such questions follow.

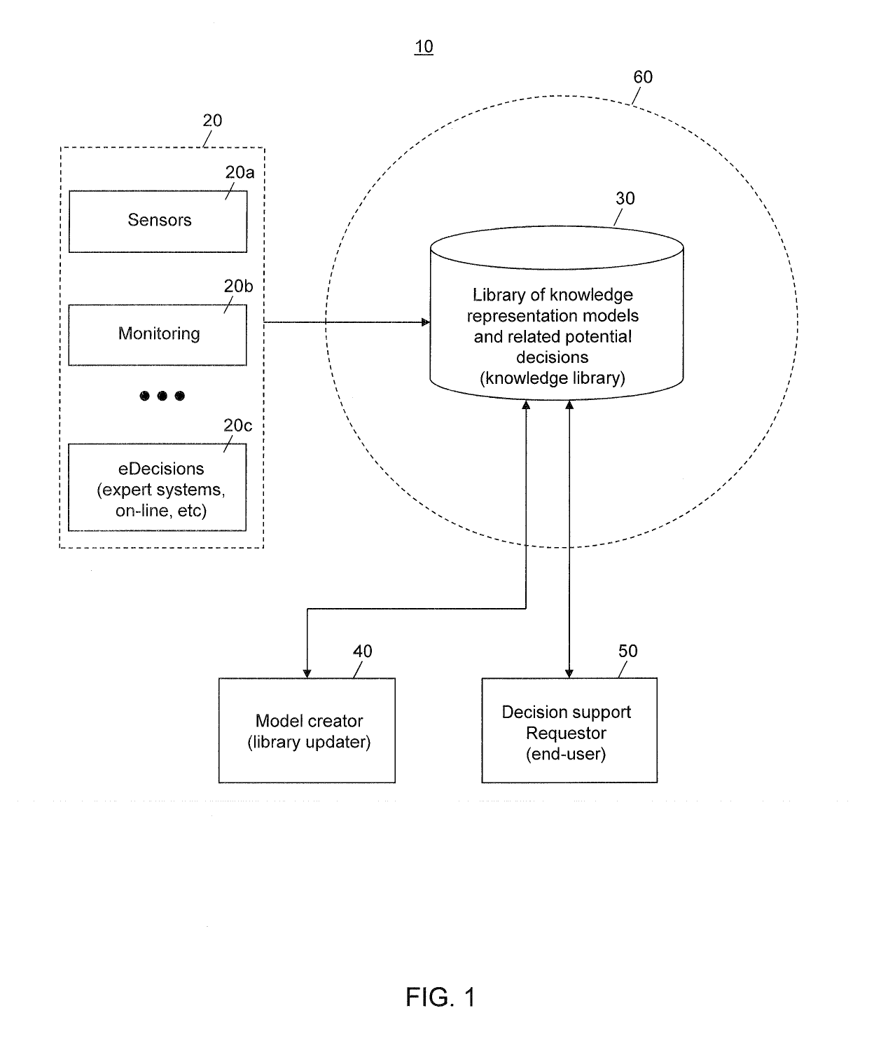

Referring now to FIG. 1, there is shown a diagram illustrating decision service components 10 according to an exemplary embodiment of the present invention. The decision service components 10 include data sources 20, a knowledge library 30, a library updater 40 and an end-user 50.

The data sources 50 include, but are not limited to, sensors 20a, monitoring devices 20b, and eDecisions 20c. Sensors 20a may monitor physical or environmental conditions, such as temperature, sound, vibration, pressure, motion or pollutants, for example. The sensors 20a may be part of a wireless sensor network, where each sensor is a node. An example of a simple sensor may be a device that measures a physical quantity and converts it into a signal that can be read by an observer or by an instrument. In a traffic context, an infrared traffic logger may be used as a sensor.

Monitoring devices 20b may be cameras, such as surveillance cameras or traffic light cameras. eDecisions 20c may refer to a variety of data sources such as expert decision systems (e.g., other DSSs, government or private weather data feeds, etc.), web interactions (e.g., details regarding a customer's purchase of a product via the web), existing databases, etc. These decision systems provide value-added data using specialized models and analytics based on an agreement of a plurality of data sources.

The knowledge library 30 includes a plurality of knowledge models and profiles. More specifically, the knowledge library 30 is a library of knowledge representation models and related potential decisions. The knowledge library 30 may be a database, collection of files or a file resource, and may be embodied in a computer memory. The knowledge library 30 may reside in a cloud environment 60. Access to the knowledge library 30 may be effectuated by the library updater 40 or the end-user 50, both of which may be constituted by computing devices (workstation computer, laptop, smartphone, tablet computer, etc.) with a wired or wireless network connection. The cloud environment 60 may refer to using multiple server computers via a digital network, as through they were one computer.

An example of a knowledge representation model is as follows:

<?xml version=“1.0” encoding=“UTF-8”?>
<attribute>
<name>“Traffic flow”</name>
<value>5</value>
<units>“cars/min”</units>
</attribute>

This model may be used to determine traffic flow between two points. The data used to populate the traffic flow model will be discussed later.

As can be seen, the traffic flow model is written in Extensible Markup Language (XML). The traffic flow model may be modified and deleted and other models may be created or removed from the knowledge library 30 by someone operating the library updater 40. In this way, the library updater 40 functions as an authoring interface to allow the development of new expertise data formats (e.g., new domains, new combinations of formats, etc.).

To this point, we have referred to the knowledge library 30 as a database; however, it may hereinafter be referred to as a knowledge builder. In this regard, we mean the database of the knowledge library 30 working in conjunction with a program (operating on the same computer as the database or a separate one) to provide decision support.

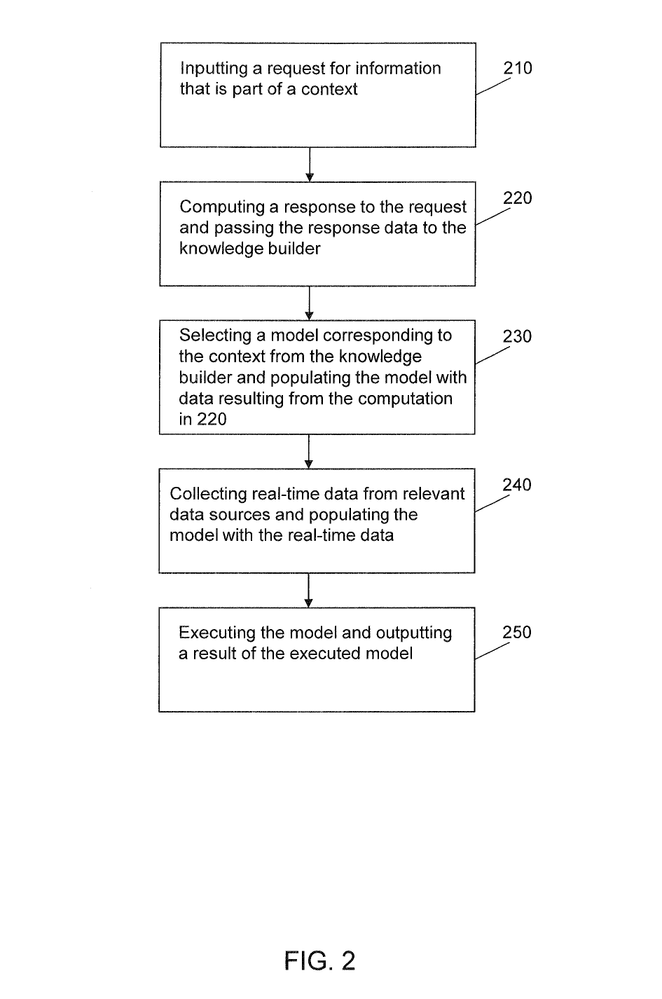

Referring now to FIG. 2, there is shown a flowchart illustrating a decision service methodology according to an exemplary embodiment of the present invention. Although the following discussion will center on a traffic context, it is to be understood that the present invention is not limited thereto.

As shown in FIG. 2, an end-user, for example, someone with a computing device, which includes an application according to an exemplary embodiment of the present invention working thereon, inputs a request for information that is part of a context (210). Here, the context is “I want to travel from home to work. What route do I take?” The application asks the user for relevant data such as “Starting location,” “Ending location,” “Mode of transport,” etc. in much the same was as GoogleMaps and Mapquest.

Once the user provides the context as input to the application, the following sequences of actions may occur. Compute the route from home to work; in this example using GoogleMaps or MapQuest, then pass the results of the computation to the knowledge builder 30 (220).

The knowledge builder 30 selects a model from its database for evaluation. This selection is based on the context of the information requested. The selection of the model may be specified by the user. The criteria for selection could be based on the price of using the model, the time to provide an answer, and/or the availability of data to complete the processing. The selected model is then populated with the results of the computation in 220 (230). This will be elucidated below.

After the model has been selected, the model needs data from external sensors or sources. This is so, because for the model produces output based on the input received from the external sensors or sources. The data is collected by the knowledge builder 30 in real-time from the data sources 20 (240). For example, a model that only uses traffic flow information, would only request data for “traffic,” while a more sophisticated traffic model incorporating “weather” information into its decisions would request information from the weather channel as well. An example of a request for real-time data is as follows:

a) SELECT*FROM Sensors WHERE type=‘camera’ AND location IN (SELECT value FROM Sensors WHERE type=‘GPS’ AND startlocation=<TACONIC_START_GPS> AND endlocation=<TACONIC_END_GPS>)

(b) SELECT*FROM Sensors WHERE type=‘camera’ AND location IN (SELECT value FROM Sensors WHERE type=‘GPS’ AND startlocation=<SAW_MILL_RIVER_START_GPS> AND endlocation=<SAW_MILL_RIVER_END_GPS>)

(c) SELECT*FROM Sensors WHERE type=‘weather’ AND location IN ZIPCODE=10532

where TACONIC_START_GPS, TACONIC_END_GPS, SAW MILL RIVER START GPS and SAW MILL RIVER END GPS are computed based on user input in 230.

A method and apparatus to support the above queries (a-c) for real-time data is described in commonly assigned U.S. application entitled “SYSTEM AND PROTOCOL TO DYNAMICALLY QUERY SENSOR DATA COLLECTIONS”, attorney docket no. YOR920110255US1 (8728-979), filed concurrently herewith and incorporated by reference herein in its entirety for all purposes.

The queries (a-c) are processed by a query processing subsystem described in the above disclosure, for example. The query processing subsystem consists of a sensor registry that includes a query dispatcher, a registration dispatcher, and a continuous query engine. The query dispatcher is configured to receive a query from a subscriber, search a sensor database for at least one sensor that satisfies the query, and return a result set corresponding to the query to the subscriber, wherein the result set includes the at least one sensor. The registration dispatcher is configured to receive a message from a requesting sensor in a sensor network, and update the sensor database based on the message. The continuous query engine is configured to receive the query from the query dispatcher, update the result set corresponding to the query based on the received message, and notify the subscriber upon determining that a change has been made to the result set. The data used by the query processing subsystem is continuously received from the sensors.

The real-time data collected from the sources referenced in the above queries (a-c) is made available as is or processed by the knowledge builder 30. The collected data may also authenticated through a set of preshared keys (e.g., a secret hash key) that assures that the sensor is authorized to provide the data.

At this time, the selected model takes the real-time data it needs, is executed and outputs a result (250). A description of how the model pulls the data based on what it needs (is populated with) is found in the aforementioned U.S. application entitled “SYSTEM AND PROTOCOL TO DYNAMICALLY QUERY SENSOR DATA COLLECTIONS”, attorney docket no. YOR920110255US1 (8728-979), and briefly discussed above.

In 250, one can think of the model as returning results back to the application, and the application choosing to provide the results to the requestor. In the above example (e.g., the traffic flow model), the model would complete the computation based on that data value and return an answer (OK) with <numeric> probability (e.g., 0.7). The data values are then communicated back to the end user via the application in a proper format. For the above example, the application may print the following text on the screen of the user's computer.
You can take the following route to travel from home to work Taconic to Sawmill South to exit 23.

There is a 30% chance that the traffic might be heavy between now and next 1 hour

Alternative ways of representing the results could be as follows. HIGHLIGHT the route with RED, YELLOW, GREEN to show heavy, moderate, or light. Further, if a more sophisticated weather-based model is selected by the user, then the model may take into account the amount of rainfall into the decision making process. As an example, if the Sawmill Road is closed due to flooding after more than two inches of rain, then a weather-based model may not recommend that route whenever there is more than two inches of rain in a 24-hour period.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

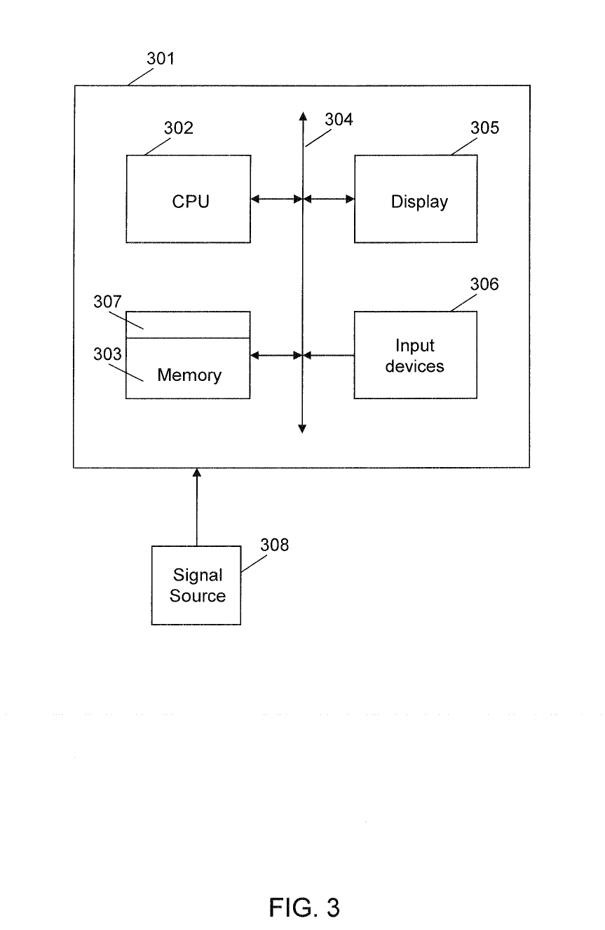

Referring now to FIG. 3, according to an exemplary embodiment of the present invention, a computer system 301 can comprise, inter alia, a central processing unit (CPU) 302, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include RAM, ROM, disk drive, tape drive, etc., or a combination thereof. Exemplary embodiments of present invention may be implemented as a routine 307 stored in memory 303 (e.g., a non-transitory computer-readable storage medium) and executed by the CPU 302 to process the signal from the signal source 308. As such, the computer system 301 is a general-purpose computer system that becomes a specific purpose computer system when executing the routine 307 of the present invention.

The computer platform 301 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving a request for information that is part of a context;
generating data in response the request;
populating a knowledge model associated with the context with the data;
populating the knowledge model with real-time data associated with the request;
executing the knowledge model; and
outputting a result of the executed knowledge model.

2. The method of claim 1, wherein the request is received from a user.

3. The method of claim 1, wherein the context is specified by a computing application.

4. The method of claim 1, wherein the knowledge model is an executable file.

5. The method of claim 1, wherein the knowledge model is written in Extensible Markup Language (XML).

6. The method of claim 1, wherein populating the knowledge model with real-time data associated with the context includes generating a query that requests only data sources associated with the context to provide the real-time data.

7. The method of claim 6, wherein the query is written as an XML string.

8. The method of claim 1, wherein the result includes a plurality of weighted decisions.

9. A computer program product, comprising:
a computer readable storage medium having computer readable program code embodied therewith, the computer readable program code comprising:
computer readable program code configured to receive a request for information that is part of a context;
computer readable program code configured to generate data in response the request;
computer readable program code configured to populate a knowledge model associated with the context with the data;
computer readable program code configured to populate the knowledge model with real-time data associated with the request; and
computer readable program code configured to execute the knowledge model.

10. The computer program product of claim 9, wherein the request is received from a user.

11. The computer program product of claim 9, wherein the context is specified by a computing application.

12. The computer program product of claim 9, wherein the knowledge model is an executable file.

13. The computer program product of claim 9, wherein the knowledge model is written in Extensible Markup Language (XML).

14. The computer program product of claim 9, wherein populating the knowledge model with real-time data associated with the context includes generating a query that requests only data sources associated with the context to provide the real-time data.

15. The computer program product of claim 14, wherein the query is written as an XML string.

16. The computer program product of claim 9, wherein the result includes a plurality of weighted decisions.

17. The computer program product of claim 9, further comprising computer readable program code configured to output a result of the executed knowledge model.

18. A system, comprising:
a memory device for storing a program; and
a processor in communication with the memory device, the processor operative with the program to:
receive a request for information that is part of a context;
generate data in response the request;
populate a knowledge model associated with the context with the data;
populate the knowledge model with real-time data associated with the request;
execute the knowledge model.

19. The system of claim 18, wherein the processor is further operative with the program code to output a result of the executed knowledge model.

20. A method, comprising:
receiving a decision support request, wherein the request is associated with a particular context;
formulating a response to the request, wherein the response is formulated by populating a knowledge representation model associated with the context with real-time data required by the model and executing the model populated with the real-time data to produce a result; and
outputting the result as the response.

21. The method of claim 20, wherein the method is implemented in a cloud computing environment.
